(19) United States
(12) Patent Application Publication
(10) Pub. No.: US 2007/0148357 A1
(43) Pub. Date: Jun. 28, 2007

(54) Fast Hardening Aqueous Coating Composition

(75) Inventors: John A. Joecken, Richfield, OH (US); Syed Y. Hasan, Strongsville, OH (US)

Correspondence Address: THE SHERWIN-WILLIAMS COMPANY, 101 PROSPECT AVENUE N.W., 1100 MIDLAND BLDG. - LEGAL DEPARTMENT, CLEVELAND, OH, 44115-1075, US

(73) Assignee: THE SHERWIN-WILLIAMS COMPANY, Cleveland, OH (US)

(21) Appl. No.: 11/538,275

(22) Filed: Oct. 3, 2006

Related U.S. Application Data
(60) Provisional application No. 60/723,136, filed on Oct. 3, 2005.

(51) Int. Cl. C08K 5/06; B05D 7/00

(52) U.S. Cl. 427/407.1; 524/366; 524/386; 524/379; 524/556; 427/408

(57) ABSTRACT

A high build, fast drying and fast hardening aqueous coating composition comprising: (a) a latex binder comprising: (i) 35 to 65% by weight, based on said latex binder weight, of at least one hard monomer; (ii) 25 to 55% by weight, based on said latex binder weight, of at least one soft monomer; and (iii) 2 to 15% by weight, based on said latex binder weight, of at least one acid functional monomer; (iv) 0.1% to 2.0% by weight, based on said latex binder weight, of at least one anionic surfactant; wherein said latex binder has a glass transition temperature less than 45° C., and wherein said latex binder has an average particle size diameter of between 160 nanometers to 240 nanometers; (b) a combination of at least two coalescing solvents selected from at least one alkyl alcohol ethoxylate, wherein at least one of the coalescing solvents has an evaporation rate greater than 0.01 and at least a second coalescing solvent has a water solubility less than 10; wherein the acid number of the coating composition is less than 10 mg of KOH per gram of polymer; and wherein the coating composition is applied to a substrate at a wet film thickness of about 2 mils to about 15 mils wet film thickness. Also, a method for providing a high build, fast drying and fast hardening aqueous coating at ambient conditions is provided.

### CROSS-REFERENCE TO RELATED APPLICATION

This application claims the benefit of U.S. provisional patent application No. 60/723,136 filed on Oct. 3, 2005, the entirety of which is hereby incorporated by reference.

Aqueous latex binders are fluid systems which contain polymer particles distributed in stable disperse form as the disperse phase in the aqueous dispersing medium. Aqueous polymer emulsions have the ability to form polymer films on evaporation of the aqueous dispersing medium, and it is for this reason that these emulsions are widely used as binders for surface coatings. The type of dispersed polymer and the temperature at which film formation takes place determine whether an aqueous polymer emulsion forms a cohesive film or a brittle, easily cracked layer after the evaporation of water. The lowest temperature at which a crack-free film is just formed is referred to as the minimum film formation temperature (MFFT) of the relevant composition.

It is generally known that aqueous emulsions of polymers that contain only polymerized monomers whose homopolymers have low glass transition temperatures, Tg, are known as soft monomers that are capable of forming polymer films at appropriately low temperatures. However, a disadvantage of the resulting films is that they are too soft and too tacky for many applications, and such films readily become soiled.

It is also generally known that aqueous emulsions of polymers that contain essentially only polymerized hard monomers (monomers whose homopolymers have a high glass transition temperature, Tg) generally require a high temperature for film formation.

In the area of traffic paint, for example, it would be desirable to have aqueous compositions that can be applied in a single coat thick application (i.e., high build), yet can dry and harden soon after application under ambient conditions and have high water resistance in the finished coatings. Problems that have been experienced with various waterborne traffic marking paint formulations are slow dry times and relatively poor durability, particularly when such formulations have been applied under humid conditions.

This invention relates to a high build, fast drying and fast hardening aqueous coating composition suitable for use as a pavement or road marking traffic paint for concrete or asphalt roads, walkways, or parking lots, or a coating for masonry, wood and other building material substrates. The high build aqueous coating composition of this invention utilizes a latex binder formed by emulsion polymerization of hard monomers and soft monomers with an acid-functional monomer in an aqueous medium. The aqueous latex binder in accordance with this invention is used in combination with at least two coalescing solvents having appropriate characteristics to provide coatings having very rapid dry times, very high solids content including a high NVM, crack resistance and moisture resistance in the applied and dried paints, which ultimately contribute to long-term durability. The aqueous coating compositions of this invention also have excellent adhesion to high traffic surfaces such as concrete, masonry, stone and brick. This invention also relates to a method for providing a high build, fast drying and fast hardening aqueous coating.

This invention relates to a high build, fast drying and fast hardening aqueous coating composition comprising: (a) a latex binder comprising: about 35 to about 65% by weight, based on said latex binder weight, of at least one hard monomer; about 25 to about 55% by weight, based on said latex binder weight, of at least one soft monomer; and about 2 to about 15% by weight, based on said latex binder weight, of at least one acid functional monomer; about 0.1 to about 2.0% by weight, based on said latex binder weight, of at least one anionic surfactant; wherein said latex binder has a glass transition temperature less than 45° C. and an average particle size diameter of between about 160 nanometers and about 240 nanometers; (b) a combination of at least two coalescing solvents selected from at least one alkyl alcohol ethoxylate, wherein at least one of the coalescing solvents has an evaporation rate greater than 0.01 and at least a second coalescing solvent has a water solubility less than 10. The acid number of the final coating composition is less than 10 mg of KOH per gram of polymer and a water solubility of less than 10.

This invention also relates to a method of producing a high build coating on a surface comprising: (I) applying to said surface a layer of an aqueous coating composition comprising: (a) a latex binder comprising: about 35 to about 65% by weight, based on said latex binder weight, of at least one hard monomer; about 25 to about 55% by weight, based on said latex binder weight, of at least one soft monomer; and about 2 to about 15% by weight, based on said latex binder weight, of at least one acid functional monomer; about 0.1% to about 2.0% by weight, based on said latex binder weight, of at least one anionic surfactant; wherein said latex binder has a glass transition temperature less than 45° C. and an average particle size diameter of between about 160 nanometers and about 240 nanometers; (b) a combination of at least two coalescing solvents selected from at least one alkyl alcohol ethoxylates, wherein at least one of the coalescing solvents has an evaporation rate greater than 0.01 and at least a second of the coalescing solvents has a water solubility less than 10; wherein the acid number of the coating composition is less than 10 mg of KOH per gram of polymer; and wherein the coating composition has a water solubility of less than 10; and (II) allowing the coating composition to dry at ambient conditions.

### DETAILED DESCRIPTION OF THE INVENTION

The high build fast hardening coating compositions of this invention as applied to a substrate at a wet film thickness of about 2 mils to about 15 mils, have very rapid dry times, lower film formation temperatures, higher moisture resistance, higher crack resistance, and high solids content and hardness in the applied dried paints. One of the aspects to obtaining the excellent characteristics lies in the combination of the aqueous latex binder of this invention with a combination of coalescing solvents with appropriate characteristics. The final coating composition has an acid number less than 10 mg of KOH per gram of polymer.

In accordance with this invention, the coating composition comprises a latex binder comprising at least one hard monomer, at least one soft monomer, and an acid functional monomer. The latex binder comprises about 35 to about 65 weight percent hard monomer, about 25 to about 55 weight percent soft monomer, about 3 to about 12 weight percent acid functional monomer, and about 0.1 to about 5.0 weight percent of an anionic surfactant, all based on the total weight percent of the latex binder.

With respect to the hard monomer, the term “hard monomer” generally means a monomer whose homopolymer has a glass transition temperature (Tg) of greater than 30° C., and includes, but is not limited to non-functional methacrylic monomers such as methyl methacrylate, ethyl methacrylate, isopropyl methacrylate, isobutyl methacrylate, isobornyl methacrylate, and mixtures thereof; and alkenyl aromatic monomers such as styrene, p-methyl styrene, methyl styrene, o-methyl styrene, o,p-dimethyl styrene, o,p-diethyl styrene, p-chlorostyrene, o-methyl-p-isopropyl styrene, o,p-dichlorostyrene, isopropyl styrene, t-butyl styrene, and mixtures thereof. The preferred hard monomers are styrene and methyl methacrylate.

The term “soft monomer” generally means a monomer whose homopolymer has a Tg of less than about −20° C., and includes nonfunctional acrylic monomers such as methyl acrylate, ethyl acrylate, butyl acrylate, isobutyl acrylate, ethyl hexyl acrylate, isodecyl methacrylate, lauryl methacrylate, tridecylmethacrylate, and mixtures thereof. The preferred soft monomers are butyl acrylate and 2-ethylhexyl acrylate.

The polymerization of these monomers can optionally include other ethylenically unsaturated copolymerizable comonomers. Also, optionally, the polymerization may be in the presence of other crosslinking monomers.

Surfactants useful in the present invention are anionic surfactants. Anionic surfactants include, but are not limited to, alkylphenolethoxylate sulfates and sulfonates, alkysulfates and sulfonates, such as ammonium lauryl ether sulfate, alkali alkylether sulfates such as sodium lauryl ether sulfate, octyl phenol ethoxylates, nonylphenol ethoxylates, sodium lauryl sulfate, phosphate esters, and mixtures thereof. Generally, the emulsion comprises about 0.1 to 5.0 weight percent anionic surfactant. Preferably, the range is between 0.4 to 1.5 weight percent surfactant. As used herein, the “weight percent surfactant” is defined as the total dry weight of the surfactant(s) used in making the polymer emulsion divided by the total weight of the monomers used in making the polymer.

The latex binder of the invention has a Tg of less than 45° C. and an average particle size of between 160 nanometers to 240 nanometers. The solids content of the latex binder is generally at least about 40 weight percent, preferably within the range of about 45 to about 60 weight percent, and more preferably within the range of 45 to about 55 weight percent.

A combination of two or more coalescing solvents selected from at least one alkyl alcohol ethoxylates is added to the latex binder. Coalescing solvents as utilized in this invention can be a blend of at least one cosolvent having little or no water solubility with a second cosolvent having high water solubility and a high evaporation rate. At least one of the coalescing solvents should have an evaporation rate greater than 0.01 and at least a second coalescing solvent should have a water solubility less than 10. The cosolvents can be selected by one skilled in the art based on desired minimum film formation temperature, dry time and desired water resistance, or other desired characteristics of the final paint composition. Some examples of coalescing solvents include alkyl alcohol ethoxylates such as propyl glycol n-propyl ether (PnP), propylene glycol methyl ether (PM), dipropylene glycol methyl ether (DPM), ethylene glycol monopropyl ether (EP), dipropylene glycol monobutyl ether (DPnB), propylene glycol (PG), diethylene glycol monobutyl ether (butyl carbitol), trimethyl pentanediol monoisobutyrate (commercially available as Texanol® from Eastman Chemical, Kingsport, Tenn.), and methanol, or mixtures thereof. Of the various coalescing solvents that can be used, generally the alkyl alcohol ethoxylates such as dipropylene glycol methyl ether (DPM) and dipropylene glycol monobutyl ether (DPnB) are most useful. For example, dipropylene glycol methyl ether (DPM) has an evaporation rate of about 0.0300 and 100% water solubility, and dipropylene glycol monobutyl ether (DPnB) has an evaporation rate of 0.0033 and a 5% water solubility. The combination of the DPnB and DPM at a weight ratio between 1.0 and 2.0, present at about 2 to about 15 weight percent based on the total weight of the latex, provides desirable minimum film formation temperature, dry time, and scrub resistance. Table 1 shows evaporation rates and water solubilities of common coalescent cosolvents.

TABLE I

| | | Evaporation | Water |
|---|---|---|---|
| Name | Coalescent/Cosolvent Description | rate | solubility |
| PnP | Propyl glycol n-propyl ether | 0.2100 | 100% |
| PM | Propylene glycol methyl ether | 0.7100 | 100% |
| DPM | Dipropylene glycol methyl ether | 0.0300 | 100% |
| EP | Ethylene glycol monopropyl ether | 0.2200 | 100% |
| DPnB | Dipropylene glycol monobutyl | 0.0033 | 5% |
| | ether | | |
| PG | Propylene glycol | 0.0050 | 100% |
| Butyl | Diethylene glycol monobutyl ether | 0.0100 | 100% |
| carbitol | | | |
| Texanol | Trimethyl pentanediol | 0.0100 | 0.1% |
| | monoisobutyrate | | |
| Methanol | Methyl alcohol | 2.0700 | 100% |
| MIBC | Methyl isobutyl carbinol | 0.4400 | 1.7% |
| NBP | n-Butyl propionate | 0.4500 | 0.2% |
| NBA | n-Butyl acetate | 1.0000 | 0.7% |

Water solubility of the coalescent solvent can be an important factor. Optimum ratios of the combination of coalescent solvents with respect to water solubility can make significant differences in dry time and other properties.

The emulsion polymers described are prepared in the form of aqueous dispersions in a conventional manner by emulsion polymerization in an aqueous medium in the presence of a free radical oxygen-containing initiator in which the monomers are mixed with the surfactants prior to being fed into the reaction vessel. The latex binders may also be prepared by other conventional methods such as simultaneous feed of the monomer mixture and surfactant mixture into the reactor and by the core/shell method.

It is preferred to add a catalyst and an activator to the polymer emulsion composition. Exemplary catalysts include, but are not limited to, t-butyl hydroperoxide, sodium persulfate, ammonium persulfate, hydrogen peroxide, and mixtures thereof. Exemplary activators include, but are not limited to, sodium bisulfite, sodium metabisulfite, and mixtures thereof. Particular suitability for preparing finely divided dispersions are alkali metal salts or ammonium salts such as sodium carbonate or ammonium persulfate, which in general is used in amounts of about 0.5 to 1% by weight, based on the total amount of latex.

A final coating formulation typically also comprises a dispersing aid, thickening aids, a biocide, pigments, extenders and fillers, and a defoamer.

The high build aqueous coating composition using the latex binder of this invention has an acid number less than 10 mg of KOH per gram of polymer, a water solubility at 25° C. of less than 10. The lower acid level is desirable for decreased water sensitivity of the final coating. While not intending to be bound to any theory, a lower acid number for the coating composition may help control the latex particle size, stability, water solubility and Tg. For traffic paints, in particular, a lower acid number can be advantageous on the heat age stability, freeze/thaw stability, dry time and scrub resistance. The high build aqueous coating compositions can be applied to surfaces of high traffic areas at high film thicknesses, such as about 2 mils to about 15 mils wet film thickness, and allowed to dry at ambient conditions. Typically, the dry film thickness of coatings of this invention is about 7.5 mils.

The coating formulations of this invention have a fast dry time, fast hardening and early water resistance and produce crack-free coating films. The resulting coating has improved dirt resistance and release, and is highly suitable for use as a fast dry coating for floors and other high traffic hard surfaces such as concrete, masonry, stone, brick. In addition, the surfaces can be smooth, rough, and/or porous, and upon drying, the coating composition forms a smooth film.

### EXAMPLES

The following examples demonstrate the preparation of exemplary latex binders within the scope of the invention, as well as paint compositions formulated using these latex binders. Unless otherwise stated, “percent” means percent-by-weight.

As used herein, the following abbreviations and terms have the following meanings:

SURFYNOL CT-324 is a dispersant, available from Air Products.

Proxel GXL is a biocide available from Avecia, Wilmington, Mass.

Texanol 12 is a 12 carbon ester alcohol, available from E.I. duPont & Company, Wilmington, Del.

NALCO 2305 is an emulsified silicone, available from Nalco, Naperville, Ill.

NATROSOL 250 HBR is a hydroxyethylcellulose, available from Hercules Inc., New York, N.Y.

DPNB is a dipropylene glycol n-butyl ether, available from Dow Chemical Company, Midland, Mich.

DPM is dipropylene glycol methyl ether, available from Dow Chemical Company, Midland, Mich.

Tamol 963 is an acrylic polymer dispersion, available from Rohm & Haas Company, Philadelphia, Pa.

### Example A

### Preparation of 28 Tg Latex Binder

A reaction vessel equipped with a mechanical stirrer is charged with a composition of 906.41 grams water, 0.30 grams sodium carbonate, 2.98 grams ammonium persulfate and 1.34 grams Abex VA-50S under nitrogen purge and heated to about 80° C. A monomer mixture is prepared by combining 635.94 grams styrene, 498.36 grams butyl acrylate, 131.15 grams 2-ethylhexyl acrylate, and 45.90 grams methacrylic acid. An initiator mixture is prepared with a mechanical stirrer by combining 89.41 grams water, 59.08 grams Abex VA-50S, 8.35 grams ammonium hydroxide (28% wt), 4.59 grams sodium carbonate and 1.67 grams ammonium persulfate. The monomer mixture is fed into the reaction vessel over a 3 hour period, during which the temperature is maintained at about 80° C. The initiator mixture is fed into the reaction vessel simultaneously over a 3 hour and 10 minute period. After the addition of the monomer and initiator feeds is completed, the temperature of the reaction mixture is held at about 85° C. for 1 hour, and then cooled to 70° C. The pH of the emulsion is adjusted to above 8.50 by the addition of 16.11 grams ammonium hydroxide in 10.25 grams water. The total solids content of the polymer is 52.50%, the viscosity is 740 cps, the average particle size of the polymer is 226 nanometers using a Malvern Light Scattering Particle Size analyzer. The glass transition temperature of the latex binder is 28° C. Also, depending on the needs of the application, additional latexes having Tg of 28° C. can be made as above and modified for varying acid numbers and particles sizes by one skilled in the art with results as illustrated in the data in Table II.

### Example B

### Preparation of 40 Tg Latex Binder

A reaction vessel equipped with a mechanical stirrer is charged with a composition of 197.11 grams of D.I. water, 0.06 grams of sodium carbonate, 0.35 grams ABEX VA-50 and 0.52 grams ammonium persulfate under nitrogen purge and heated to 75° C. Meantime a surfactant solution is prepared with a composition of 17.50 grams D.I. water, 0.30 grams ammonium persulfate, 10.13 grams ABEX VA-50, and 1.4 grams ammonium hydroxide. In a separate container a monomer blend is prepared with a composition of styrene 106.51 grams, methyl methacrylate 11.66 grams, butyl acrylate 70.98 grams, 2-ethylhexyl acrylate 23.3 grams and methacrylic acid 21.0 grams. The surfactant solution and monomer blend is fed into the reaction vessel over a four hour period during which the temperature is maintained at 75° C. to 78° C. The batch is held at this temperature until the required conversion is achieved and then cooled to 35° C. The pH of the polymer is adjusted to pH 9.0 with ammonium hydroxide.

### Examples 1-10

### Formulation of Coatings

The latex binders of Examples A and B are formulated into waterborne fast dry coating compositions according to the paint formulas described in Table II.

To test for scrub resistance, glass panels are coated with the coating compositions of Examples 1-10. The sample panels for evaluation are prepared by making a 7 mil wet thick drawdown of the paint composition. The film is allowed to air dry for 7 days and subjected to >400 cycles, or until failure, on a Gardner scrub machine. The results of the scrub resistance evaluations are shown in Table IV.

Paints of Examples 1-10 and those comprising the cosolvents DPnB and DPM are also evaluated for MFFT, dry times, crack resistance, and moisture resistance. The results of these evaluations are also set forth in Table V below.

TABLE II
Formulations for Fast Dry Coating Compositions

| | Paint number | | | | | |
|---|---|---|---|---|---|---|
| | Example 1 | Example 2 | Example 3 | Example 4 | Example 5 | Example 6 |
| Tg of emulsion | 40° C. | 28° C. | 28° C. | 28° C. | 28° C. | 28° C. |
| Latex binder | 83.88 | 81.17 | 83.80 | 81.17 | 81.17 | 81.18 |
| Water | 7.63 | 14.70 | 7.63 | 12.61 | 13.05 | 10.95 |
| Defoamer | 0.60 | 0.50 | 0.38 | 0.50 | 0.50 | 0.50 |
| Surfynol CT324 | 0.35 | — | 0.25 | — | — | — |
| Tamol 963 | — | 1.40 | — | 1.40 | 1.40 | 1.40 |
| Igepal CO630 | — | 0.40 | — | 0.40 | 0.40 | 0.40 |
| Benzoisothiazoline | 0.04 | 0.04 | 0.04 | 0.04 | 0.04 | 0.04 |
| High gloss TiO2 | 14.00 | 12.00 | 14.00 | 12.00 | 12.00 | 12.00 |
| Calcium carbonate | 161.16 | 146.00 | 161.00 | 146.00 | 146.00 | 146.00 |
| Methanol | 8.96 | 6.00 | 7.00 | 6.00 | 6.00 | 6.00 |
| Natrasol 250 HBR | 0.11 | 0.22 | 0.11 | 0.22 | 0.22 | 0.22 |
| Aq. Ammonia | 0.60 | 0.60 | 0.60 | 0.60 | 0.60 | 0.60 |
| Butyl carbitol | 0.25 | — | 1.00 | — | — | |
| DPnB | — | — | — | 3.46 | — | 3.46 |
| DPM | — | | — | 2.12 | — | 2.12 |
| Texanol | 2.96 | 3.76 | 2.96 | — | 3.76 | |
| Defoamer | 0.38 | 0.50 | 0.38 | 0.50 | 0.50 | 0.50 |
| Water | 2.49 | 1.39 | 0.00 | 1.39 | 1.39 | 1.39 |
| Nalco 2305 | 0.11 | 0.26 | 0.26 | 0.26 | 0.26 | 0.26 |
| Latex number | Example B | Example A | Example A | Example A | Example A | Example A |
| Acid number | 7.00 | 7.00 | 7.00 | 7.00 | 3.50 | 3.50 |
| Particle size | 170 | 210 | 170 | 210 | 201 | 201 |
| Paint results | | | | | | |
| Film Thickness (dry) | | | | | | |
| Scrubs | 400 | 250 | 400 | 574 | 460 | 663 |
| Dry time | 10 min | 13 min | 10 min | 20 min | 12 min | 15 min |
| Crack resistance | Excellent | Excellent | Excellent | Excellent | Excellent | Excellent |
| Moisture resistance | Excellent | Excellent | Excellent | Excellent | Excellent | Excellent |

| | Paint number | | | |
|---|---|---|---|---|
| | Example 7 | Example 8 | Example 9 | Example 10 |
| Tg of emulsion | 28° C. | 28° C. | 28° C. | 28° C. |
| Latex binder | 81.17 | 81.17 | 83.38 | 83.38 |
| Water | 13.96 | 15.47 | 12.38 | 12.38 |
| Defoamer | 0.50 | 0.50 | 0.50 | 0.50 |
| Surfynol CT324 | | | | |
| Tamol 963 | 1.40 | 1.40 | 1.40 | 1.40 |
| Igepal CO630 | 0.40 | 0.40 | 0.40 | 0.40 |
| Benzoisothiazoline | 0.04 | 0.04 | 0.04 | 0.04 |
| High gloss TiO2 | 12.00 | 12.00 | 12.00 | 12.00 |
| Calcium carbonate | 146.00 | 146.00 | 146.00 | 146.00 |
| Methanol | 6.00 | 6.00 | 6.00 | 6.00 |
| Natrasol 250 HBR | 0.22 | 0.22 | 0.22 | 0.22 |
| Aq. Ammonia | 0.60 | 0.60 | 0.60 | 0.60 |
| Butyl carbitol | | | | |
| DPnB | 1.73 | 0.86 | 2.64 | 2.64 |
| DPM | 1.06 | 0.53 | 1.62 | 1.62 |
| Texanol | | | | |
| Defoamer | 0.50 | 0.50 | 0.50 | 0.50 |
| Water | 1.39 | 1.39 | 1.39 | 1.39 |
| Nalco 2305 | 0.26 | 0.26 | 0.26 | 0.26 |
| Latex number | Example A | Example A | Example A | Example A |
| Acid number | 3.50 | 3.50 | 3.50 | 3.50 |
| Particle size | 256 | 292 | 164 | 262 |
| Paint results | | | | |
| Scrubs | 290 | 160 | 715 | 432 |
| Dry time | 15 min | 13 min | 12 min | 18 min |
| Crack resistance | Excellent | Excellent | Excellent | Excellent |
| Moisture resistance | Excellent | Excellent | Excellent | Excellent |

A comparison of the minimum film formation temperature is conducted on samples with varying ratios of DPNB and DPM.

TABLE III
MFFT of 28 Tg latex with DPNB and DPM:

| | Film | | | | | | |
|---|---|---|---|---|---|---|---|
| | Thickness | Coating | DPNB | % wt | DPM | % wt | MFFT |
| Sample | (wet) | (g) | (g) | DPNB | (g) | DPM | (° C.) |
| A | 15 mil | 40 | 1.71 | 8.56 | 1.04 | 5.25 | −5 |
| B | 15 mil | 40 | 0.92 | 4.62 | 0.56 | 2.81 | 1 |
| C | 15 mil | 40 | 0.43 | 2.16 | 0.26 | 1.30 | 10 |
| D | 15 mil | 40 | 0.21 | 1.05 | 0.13 | 0.65 | 18 |
| E | 15 mil | 40 | 1.71 | 8.56 | 0 | 0 | −2 |
| F | 15 mil | 40 | 0 | 0 | 1.04 | 5.25 | 14 |
| G | 15 mil | 40 | 0 | 0 | 0 | 0 | 26 |

TABLE IV
DPnB:DPM coslvent ratio impact on dry time and scrub resistance.

| | Film | | | |
|---|---|---|---|---|
| | Thickness | DPnB:DPM | | |
| Paint | (wet) | ratio | Dry time | Scrubs |
| Example 6 | 15 mil | 2.0:1.0 | 19 min | 580 |
| Example 6 | 15 mil | 3.0:1.0 | 21 min | 770 |
| Example 6 | 15 mil | 0.50:1.0 | 20 min | 665 |
| Example 6 | 15 mil | 1.0:1.0 | 22 min | 669 |

TABLE V

| | | Paint | Scrubs | Scrubs |
|---|---|---|---|---|
| | Coalescents | MFFT | test | control |
| Latex (420#) | (# lb) | (° C.) | (cycles) | (cycles) |
| Commerically | 18.8# Texanol | 7.0 C. | >400 | |
| available Styrene | | | | |
| Acrylic latex | | | | |
| (Control) | | | | |
| Latex 7% MAA | 17.3# DPnB, | −3.6 C. | 570 | 574 |
| | 10.6# DPM | | | |
| Latex 3.5% MAA | 8.7# DPnB, | 5.2 C. | 526 | 400 |
| | 5.3# DPM | | | |
| | 13.2# DPnB, | 1.0 C. | 706 | 470 |
| | 8.1# DPM | | | |
| | 17.3# DPnB, | −2.4 C. | 620 | 530 |
| | 10.6# DPM | | | |

The following table provides results for minimum film formation temperature (MFFT), dry time, and scrub resistance for latex having 28° C. Tg containing DPnB and DPM cosolvents:

Although the invention has been described in considerable detail with reference to certain preferred versions thereof; other versions are possible. For example, the coating compositions can include one or more ingredients that enhance other film properties such as gloss, etc. Therefore, the spirit and scope of the claims should not necessarily be limited to the description of the preferred embodiments contained herein.

We claim:

1. A high build, fast drying and fast hardening aqueous coating composition comprising:
(a) a latex binder comprising:
(i) 35 to 65% by weight, based on said latex binder weight, of at least one hard monomer;
(ii) 25 to 55% by weight, based on said latex binder weight, of at least one soft monomer; and
(iii) 2 to 15% by weight, based on said latex binder weight, of at least one acid functional monomer;
(iv) 0.1% to 2.0% by weight, based on said latex binder weight, of at least one anionic surfactant;
wherein said latex binder has a glass transition temperature less than 45° C., and wherein said latex binder has an average particle size diameter of between 160 nanometers to 240 nanometers
(b) a combination of at least two coalescing solvents selected from at least one alkyl alcohol ethoxylate, wherein at least one of the coalescing solvents has an evaporation rate greater than 0.01 and at least a second coalescing solvent has a water solubility less than 10;
wherein the acid number of the coating composition is less than 10 mg of KOH per gram of polymer.

2. The composition of claim 1, wherein said glass transition temperature of the latex binder is between about 25° C. and about 40° C.

3. The composition of claim 1, wherein the composition can be applied to a surface at between about 2 mils and 15 mils film thickness, and dried at ambient temperature.

4. The composition of claim 1, wherein the at least two coalescing solvents can be selected from any mixture of propyl glycol n-propyl ether, propylene glycol methyl ether, dipropyl glycol methyl ether, ethylene glycol monopropyl ether, dipropylene glycol monobutyl ether, propylene glycol, diethylene glycol monobutyl ether, trimethyl pentanediol monoisobutyrate, and methanol.

5. The coating composition of claim 1 wherein the at least two coalescing solvents are dipropylene glycol n-butyl ether and dipropylene glycol methyl ether.

6. The composition of claim 1, wherein the coalescing solvents dipropylene glycol n-butyl ether and dipropylene glycol methyl ether are present in a weight ratio of between 1.0 and 2.0.

7. The composition of claim 1, wherein the at least one acid functional monomer is less than 5% by weight, based on the weight of the latex binder.

8. The coating composition of claim 1 wherein the hard monomer is an alkenyl aromatic monomer.

9. The coating composition of claim 1 wherein the hard monomer is a non-functional methacrylic monomer.

10. A method of providing a high build, fast drying coating on a substrate surface comprising: I) applying to said substrate surface a layer of a high build, fast drying and fast hardening aqueous coating composition comprising: (a) a latex binder comprising: about 35 to about 65% by weight, based on said latex binder weight, of at least one hard monomer; about 25 to about 55% by weight, based on said latex binder weight, of at least one soft monomer; and about 2 to about 15% by weight, based on said latex binder weight, of at least one acid functional monomer; about 0.1% to about 2.0% by weight, based on said latex binder weight, of at least one anionic surfactant; wherein said latex binder has a glass transition temperature less than 45° C., and wherein said composition has an average particle size diameter of between 160 nanometers to 240 nanometers; (b) a combination of at least two coalescing solvents selected from at least one alkyl alcohol ethoxylates, wherein at least one of the coalescing solvents has an evaporation rate greater than 0.01 and at least a second coalescing solvent has a water solubility less than 10; wherein the acid number of the coating composition is less than 10 mg of KOH per gram of polymer; and wherein the coating composition has a water solubility of less than 10; and wherein said coating composition is applied as a single coat at a thickness of between about 2 mils to about 15 mils film thickness; and (II) allowing the coating composition to dry at ambient conditions.

11. The method of claim 10, wherein the substrate is selected from the group consisting of concrete, asphalt, masonry, wood, stone and brick.
